(19) United States
(12) Patent Application Publication
(10) Pub. No.: US 2006/0145060 A1
(43) Pub. Date: Jul. 6, 2006

(54) Photo-sensing device

(76) Inventor: Chin-Yuan Lin, Taichung City (TW)

Correspondence Address: RABIN & Berdo, PC, 1101 14TH STREET, NW, SUITE 500, WASHINGTON, DC, 20005, US

(21) Appl. No.: 11/320,657

(22) Filed: Dec. 30, 2005

(30) Foreign Application Priority Data
Dec. 30, 2004 (TW) 93141536

(51) Int. Cl. H01J 40/14; G01J 1/44

(52) U.S. Cl. 250/214 R

(57) ABSTRACT

A photo-sensing device includes a light emitting part, a light receiving part, and a housing. The light emitting part emitting a beam of light to the light receiving part, and the housing contains the light emitting part and the light receiving part. The housing includes at least an opening, and the opening is covered by an insulation component to prevent electrostatic charges from damaging the photo-sensing device.

This application claims the benefit of Taiwan application Serial No. 93141536, filed Dec. 30, 2004, the subject matter of which is incorporated herein by reference.

### BACKGROUND OF THE INVENTION

1. Field of the Invention

The invention relates in general to a photo-sensing device, and more particularly to a photo-sensing device capable of preventing electrostatic charges from damaging interior components.

2. Description of the Related Art

FIG. 1 is an upward view of a conventional photo-sensing device. Referring to FIG. 1, the photo-sensing device 100 includes a light emitting part, a light receiving part 120, a housing 130 and a block device 140. The light emitting part 110 is for emitting a beam of light L to the light receiving part 130. The housing 130, containing the light emitting part 110 and the light receiving part 120, has respectively sensor windows 112 and 133 corresponding to the light emitting part 110 and light receiving part 120. The light L emitted from the light emitting part 110 to the light receiving part 120 via the two sensor windows 112 and 122. Moreover, the block device 140 is for blocking the light L to generate the required electric signal 0 or 1 at the printed circuit board (PCB) 150. For example, the electric signal is 0 as the block device 140 blocks the light L, while the electric signal is 1 as the block device 140 doesn't block the light L.

The block device 140 includes a block plate 142, a pivot 144, and a spring 146. The block device 140 is connected to the pivot 144 while the spring, connected to the pivot 144, has an end A, connected to the block plate 142, and the other end B, connected to the housing 130. The spring 146 is for providing a restoring force as the block plate 142 is triggered. Moreover, a fabrication gap usually exits between the housing 130 and the printed circuit board 150. When a human body contacts with the photo-sensing device, electrostatic charges of the human body can easily be propagated into the photo-sensing device 100 through the sensor windows 112 and 122, the fabrication gap 152 and two ends A, B of the spring 146, thereby causing signal errors or component damage.

### SUMMARY OF THE INVENTION

It is therefore an object of the invention to provide a photo-sensing device. By using insulation materials to obscure the sensor windows, fabrication gap, and spring ends, discharge paths can be effectively blocked to prevent electrostatic charges from causing signal distortion or component damage.

The invention achieves the above-identified object by providing a photo-sensing device including a light emitting part, a light receiving part, and a housing. The light emitting part emits a beam of light to the light receiving part. The housing contains the light emitting part and the light receiving part and has an opening. The opening is covered by an insulation component to prevent electrostatic charges from damaging the photo-sensing device.

The invention achieves the above-identified object by providing a photo-sensing device including a light emitting part, a light receiving part, a housing, and a block device. The light emitting part emits a beam of light to the light receiving part. The housing contains the light emitting part and the light receiving part, and has at least an opening. The block device is for blocking the light to generate electric signals. The block device includes a pivot, a block plate, and a spring. The block plate is connected to the pivot, and the spring, connected pivotally to the pivot, for applying a restoring force to the block plate as the block plate is triggered. The spring has a first end and a second end, for respectively connecting to the block plate and the housing. The opening is covered by a first insulation component to prevent electrostatic charges from damaging the photo-sensing device, and each of the first end and the second end of the spring is covered by a second insulation component to prevent electrostatic charges from damaging the photo-sensing device.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is an upward view of a conventional photo-sensing device.

FIG. 2 is an upward view of a photo-sensing device according to a preferred embodiment of the invention.

FIG. 3A is a partial schematic diagram of the photo-sensing device having a transparent insulation plate disposed on the surface of the housing to cover the sensor windows according to the preferred embodiment of the invention.

FIG. 3B is a partial schematic diagram of the photo-sensing device having a transparent insulation plate disposed inside the housing to cover the sensor windows according to the preferred embodiment of the invention.

FIG. 4A is a partial schematic diagram of the photo-sensing device using an insulation plate to completely cover the fabrication gap according to the preferred embodiment of the invention.

FIG. 4B is a partial schematic diagram of the photo-sensing device using an insulation plate stretching from the housing to cover the fabrication gap according to the preferred embodiment of the invention.

FIG. 4C is a partial schematic diagram of the photo-sensing device using melt glue to seal the fabrication gap according to the preferred embodiment of the invention.

FIG. 5 is a partial schematic diagram of the photo-sensing device using melt glue to seal two ends of the spring in a block device according to the preferred embodiment of the invention.

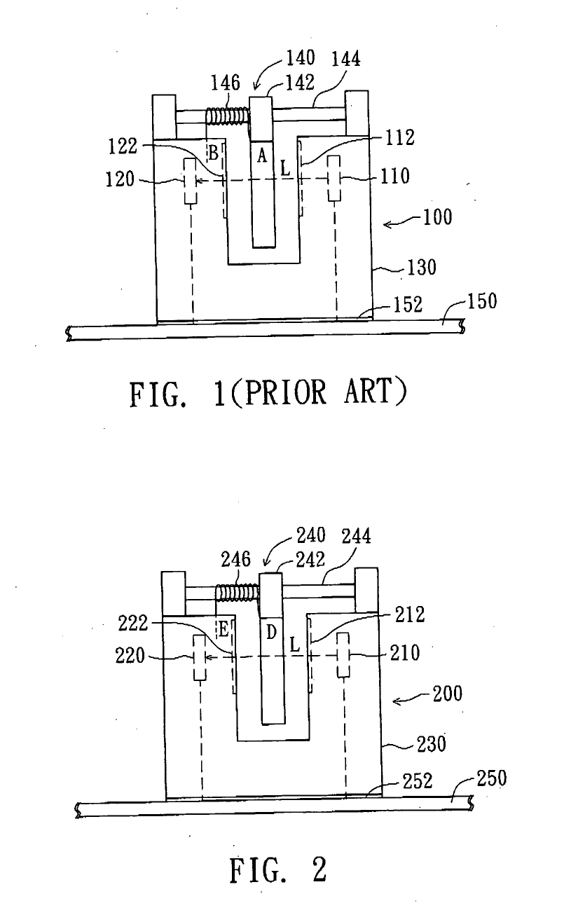

### DETAILED DESCRIPTION OF THE INVENTION

Referring to FIG. 2, an upward view of a photo-sensing device according to a preferred embodiment of the invention is shown. The photo-sensing device 200 includes a light emitting part 210, a light receiving part 220, a housing 230, and a block device 240. The light emitting part 210 is for emitting a beam of light L, while the light receiving part 220 is for receiving and converting the light L into a signal to be transmitted to a printed circuit board 250. The housing 230, containing the light emitting part 210 and the light receiving part 220, includes sensor windows 212 and 222. The light L emitted from the light emitting part 210 passes through the two sensor windows 212 and 222 to the light receiving part 220.

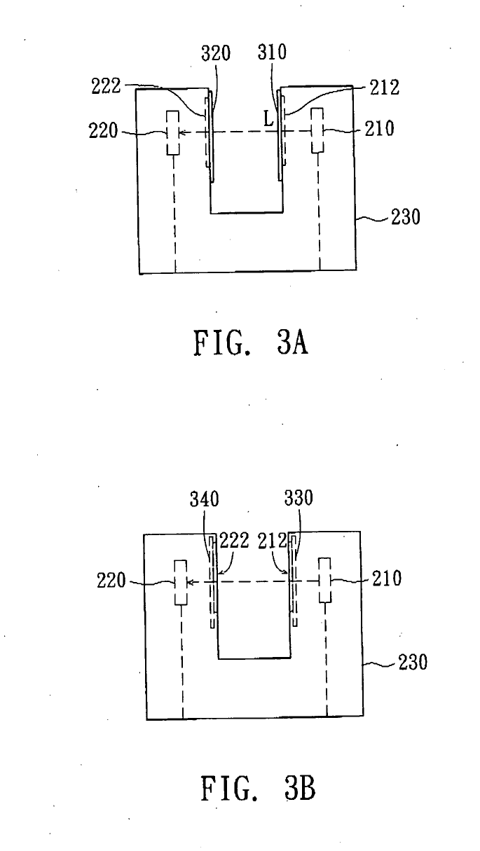

In order to prevent electrostatic charges from entering the two sensor windows 212 and 222 to damage the photo-sensing device 200, transparent insulation plates 310 and 320, made of a Mylar material for instance, are disposed on the surface of the housing 230 to respectively cover the two sensor windows 212 and 222, as shown in FIG. 3A. Or transparent insulation plates 330 and 340 are disposed inside the housing 230 to respectively cover the two sensor windows 212 and 222, as shown in FIG. 3B. Therefore, the two sensor windows 212 and 222 can be effectively blocked from forming discharge paths for electrostatic charges to enter the photo-sensing device 200 and cause signal distortion or component damage.

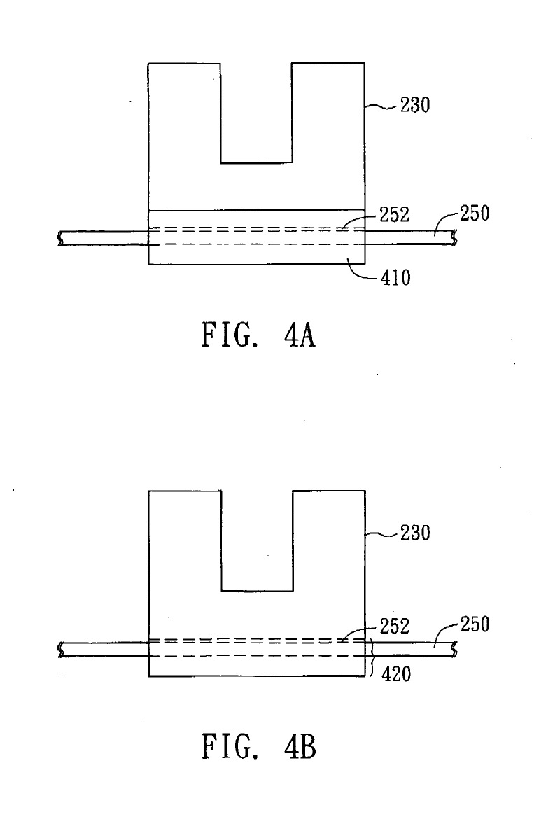

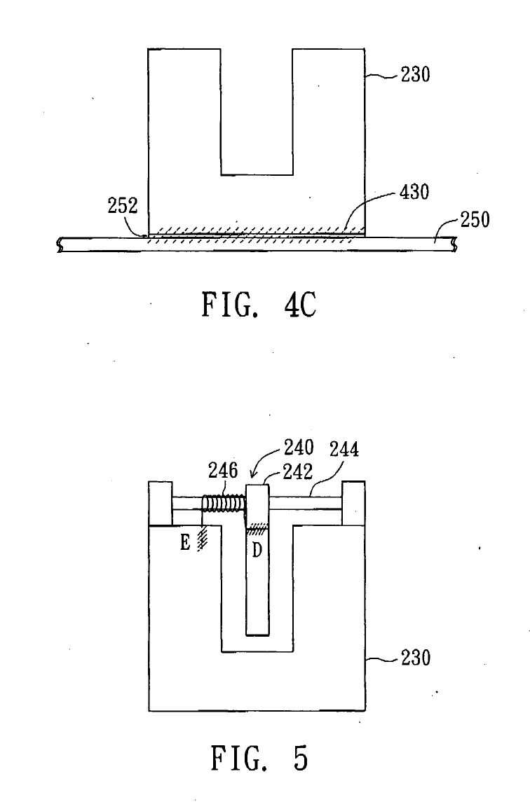

Furthermore, a fabrication gap usually exits between the housing 230 and the printed circuit board 250. In order to prevent electrostatic charges from entering and damaging the photo-sensing device 200 via the fabrication gap 252, an insulation plate 410, made of a Mylar material for instance, can be used to completely cover the fabrication gap, as shown in FIG. 4A. Or the end of the housing 230 having the fabrication gap 252 can be stretched to form an insulation plate 420 to cover and block the fabrication gap 252 from electrostatic charges, as shown in FIG. 4B. Or melt glue 430 can be used to seal the fabrication gap 252 directly, as the dash lines shown in FIG. 4C. Therefore, the fabrication gap 252 can be blocked from forming discharge paths for electrostatic charges to enter the photo-sensing device 200 and cause signal distortion or component damage.

Moreover, as shown in FIG. 2, the photo-sensing device 200 further includes a block device 240, for blocking the light L to generate the required electric signals (0, 1) at the printed circuit board 250. The block device 240 includes a block plate 242, a pivot 244, and a spring 246. The block plate 242, connected to the pivot, can rotate around the pivot. An electric signal 0 is outputted to the printed circuit board 250 as the block plate 242 blocks the light L (in a trigger state), while an electric signal 1 is outputted to the printed circuit board 250 as the block plate 242 doesn't block the light L. The spring 246 is connected pivotally to the pivot 244 for providing an elastic restoring force to the block plate 242 as triggered. The spring 246 has one end D connected to the block plate 242 and the other end E connected to the housing 230.

In order to prevent electrostatic charges from entering and damaging the photo-sensing device 200 as guided into from the two ends D, E of the spring 246 and propagated through the above-mentioned sensor windows 212, 222 or the fabrication gap 252, melt glue 510 can be used to seal the two ends D and E, as the dash lines shown in FIG. 5. Besides, the spring 246 can also be made of insulation materials directly to block electrostatic charges. Therefore, the two ends D and E of the spring 246 can be effectively blocked from forming discharge paths for the electrostatic charges to enter the photo-sensing device 200 and cause signal distortion or component damage.

The photo-sensing device according to the above-mentioned embodiment of the invention has advantages as follows. Static electricity damage can be effectively prevented by using transparent insulation materials to cover the sensor windows of the housing, and insulation materials or melt glue to obscure the fabrication gap on the housing, and performing an insulation processing on spring components of the block device. According to a test result of a simulation experiment on human body static electricity discharge, the photo-sensing device of the invention can exactly be blocked from forming discharge paths for the electrostatic charges to enter and cause output signal distortion or interior component damage.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A photo-sensing device, comprising:
a light emitting part, for emitting a beam of light;
a light receiving part, for receiving the light; and
a housing, for containing the light emitting part and the light receiving part, the housing comprising an opening;
wherein the opening is covered by an insulation component to prevent electrostatic charges from damaging the photo-sensing device.

2. The photo-sensing device according to claim 1, wherein the insulation component is made of a transparent material and disposed on the surface of the housing and the light radiates from the light emitting part out of the housing via the opening and the insulation component successively.

3. The photo-sensing device according to claim 1, wherein the insulation component is made of a transparent material and disposed inside the housing, and the light radiates from the light emitting part out of the housing via the insulation component and the opening successively.

4. The photo-sensing device according to claim 1, wherein the insulation component is made of a transparent material and disposed on the surface of the housing, and the light radiates to the light receiving part via the insulation component and the opening successively.

5. The photo-sensing device according to claim 1, wherein the insulation component is made of a transparent material and disposed inside the housing, and the light radiates to the light receiving part via the opening and the insulation component successively.

6. The photo-sensing device according to claim 1, wherein the opening is a fabrication gap, and the insulation component is an insulation plate completely covering the fabrication gap.

7. The photo-sensing device according to claim 1, wherein the opening is a fabrication gap, the housing is made of an insulation material, and the insulation component is an insulation plate stretched from one end of the housing to cover the fabrication gap.

8. The photo-sensing device according to claim 1, wherein the opening is a fabrication gap, and the insulation component is melt glue for sealing the fabrication gap.

9. The photo-sensing device according to claim 1, further comprising a printed circuit board for processing an electric signal generated by the photo-sensing device, wherein the opening is an gap between the housing and the printed circuit board generated in fabrication.

10. The photo-sensing device according to claim 9, wherein the component is an insulation plate completely covering the fabrication gap.

11. The photo-sensing device according to claim 9, wherein the housing is made of an insulation material, and the insulation component is an insulation plate stretched from one end of the housing to cover the gap.

12. The photo-sensing device according to claim 9, wherein the insulation component is melt glue for sealing the fabrication gap.

13. The photo-sensing device according to claim 1, wherein the insulation component is made of a Mylar material.

14. A photo-sensing device, comprising:
a light emitting part, for emitting a beam of light;
a light receiving part, for receiving the light;
a housing, for containing the light emitting part and the light receiving part, the housing comprising at least an opening; and
a block device, for block the light to generate electric signals, the block device comprising:
a pivot;
a block plate, connected to the pivot; and
a spring, connected pivotally to the pivot, for applying a restoring force to the block plate as the block plate is triggered, the spring having a first end and a second end, for respectively connecting to the block plate and the housing;
wherein the opening is covered by a first insulation component to prevent electrostatic charges from damaging the photo-sensing device, and each of the first end and the second end of the spring is covered by a second insulation component to prevent electrostatic charges from damaging the photo-sensing device.

15. The photo-sensing device according to claim 14, wherein the second insulation component is melt glue for sealing the first end and the second end of the spring.

16. The photo-sensing device according to claim 14, wherein the spring is made of an insulation material, and the second insulation component is a stretching part of the first end and the second end of the spring.
